(19) United States
(12) Patent Application Publication
(10) Pub. No.: US 2009/0135311 A1
(43) Pub. Date: May 28, 2009

(54) DISPLAY APPARATUS AND IMAGE PROCESSING DEVICE

(75) Inventors: Toshiyuki KURITA, Yokohama (JP); Hitoaki Owashi, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 12/248,340

(22) Filed: Oct. 9, 2008

(30) Foreign Application Priority Data
Nov. 28, 2007 (JP) 2007-306746

(51) Int. Cl. H04N 5/66

(52) U.S. Cl. 348/739; 348/E05.133

(57) ABSTRACT

A display apparatus includes a first communication unit connectable with an external image processing device via a predetermined wired interface for receiving image information from the external image processing device, a second communication unit connectable with the external image processing device via a predetermined wireless interface for receiving the image information from the external image processing device, and a display unit for displaying an image based on at least one of pieces of the image information received in the first and second communication units. When an acquisition request for receiving the image information based on the wireless interface is issued to the second communication unit, information relating to the acquisition request is output from the first communication unit via the wireless interface to the image processing device.

### INCORPORATION BY REFERENCE

The present application claims priority from Japanese application JP2007-306746 filed on Nov. 28, 2007, the content of which is hereby incorporated by reference into this application.

### BACKGROUND OF THE INVENTION

The present invention relates to a technique for displaying image information from image processing device connected to a display apparatus via a wired and/or wireless interface on the display apparatus.

In order to watch or listen to a video or the like by connecting an image processing device to an image display apparatus as another image processing device, there has been used a method of transmitting a video signal and an audio signal via analog connection. From the viewpoint of avoiding picture quality deterioration and protecting copyright, however, as digital devices are increasingly spread, there has been employed a method of digitally connecting to a device, encrypting the video and audio signals, and transmitting the encrypted signals via the digital connection thereto.

As an example of digital transmission, an HDMI (High Definition Multimedia Interface) system is known. In the HDMI system, a baseband signal and an audio signal in a high resolution video signal are time-division multiplexed for encryption called HDCP (high definition copy protocol), and then transmitted.

Such a prior art technique as to multiplex and transmit digitalized video and audio signals is disclosed, for example, in JP-A-2007-202115. With respect to the HDMI system, wireless connection has been studied and advanced and a standard such as WiHD or WHDI has been developed, for example, as explained in non-patent documents, magazines entitled Nikkei Electronics, 2005, July 18, pp. 61-70 and 2006, November 20, pp. 34-35.

### SUMMARY OF THE INVENTION

The HDMI system is assumed to be used to connect fixed devices together placed in a home. However, sufficient consideration is not paid to convenient connection between such a portable device as a digital camera or a cellular phone and an image display apparatus or between such a fixed image processing device as a tuner or a set top box for receiving a digital broadcast program and a portable image display apparatus.

The connection between an image processing device and an image display apparatus is predominantly based on the HDMI system. For the purpose of further increasing user's convenience, however, appearance of a wireless standard easily compatible with the HDMI system has been demanded. To this end, it is required for the image display apparatus to suitably attain compatibility with the existing HDMI system and with the future wireless Standard, because the image display apparatus has been used for a long period of years.

In view of the problems in the prior art, it is therefore an object of the present invention to provide a technique for increasing user's convenience, for example, when an image obtained from a portable image processing device such as a camera or a cellular phone is displayed on a display apparatus. In particular, an object of the present invention is to provide a technique for being capable of continuously viewing the image information from the image processing device, in particular, when it is desired to display the image information from the image processing device on a display apparatus via a wired interface or even when the display apparatus is carried and moved.

In accordance with an aspect of the present invention, there is provided a display apparatus which includes a first communication unit connectable with an external image processing device via a predetermined wired interface for receiving an image information from the external image processing device, a second communication unit connectable with the external image processing device via a predetermined wireless interface for receiving image information from the external image processing device, and a display unit for displaying an image based on at least one of two pieces of the image information received in the first and second communication units. When an image information acquirement request is issued to the second communication unit to receive the image information based on the wireless interface, information on the image information acquirement request is output from the first communication unit via the wired interface.

In such a display apparatus, since the first communication unit for receiving the image information from the external image processing device is connected to the external image processing device via the predetermined wired interface, the connection can be achieved to be immune to disturbance with a stable transmission quality, a high security, and a low power consumption.

Further, since the second communication unit for receiving the image information from the external image processing device is connectable to the external image processing device via the predetermined wireless interface, the connection can be achieved with a high flexibility in the arrangement and attitude between connection target devices and with a high user's convenience.

The display unit displays the image via the wired interface for the image information from the external image processing device. When it is desired to move the display apparatus while displaying the image thereon, the user gives the image information acquirement request to the second communication unit using, e.g., a remote controller. A controller for the display apparatus interprets the image information acquirement request and issues an instruction to transmit the image information from the first communication unit via the external image processing device to the external image processing device and to cause the external image processing device to the image information to the wireless interface. Thus, since the external image processing device transmits the image information via the wireless interface to the display apparatus, the display apparatus can receive the image information from the external image processing device even when the external image processing device is removed. As a result, when it is desired to display an image from a image processing device on a portable display apparatus, user's convenience can be improved.

In accordance with the present invention, user's convenience when it is desired to connect the image processing device and the display apparatus via the wireless or wired interface to display image information can be increased.

Other objects, features and advantages of the invention will become apparent from the following description of the embodiments of the invention taken in conjunction with the accompanying drawings.

### BRIEF DESCRIPTION OF THE DRAWINGS

FIG. 1 shows an embodiment of the present invention;

FIG. 2 shows and example of an image processing device 100 in the embodiment of the present invention;

FIG. 3A shows an example of control information recorded in the image processing device 100;

FIG. 3B shows an example of control information recorded in an image display apparatus 200;

FIG. 4 shows an example of the image display apparatus 200 in the embodiment of the present invention;

FIG. 5 shows another example of the image display apparatus 200 in the embodiment of the present invention;

FIG. 6 shows an example of a system when two image processing devices are connected wirelessly;

FIG. 7 shows another example of the system when the two image processing devices are connected wirelessly;

FIG. 8 shows an example of an arrangement of an HDMI interface; and

FIG. 9 shows how to control the image display apparatus in the present invention.

### DESCRIPTION OF THE EMBODIMENTS

The present invention will be explained in connection with preferable embodiments of the present invention, with reference to the attached drawings.

### Embodiment 1

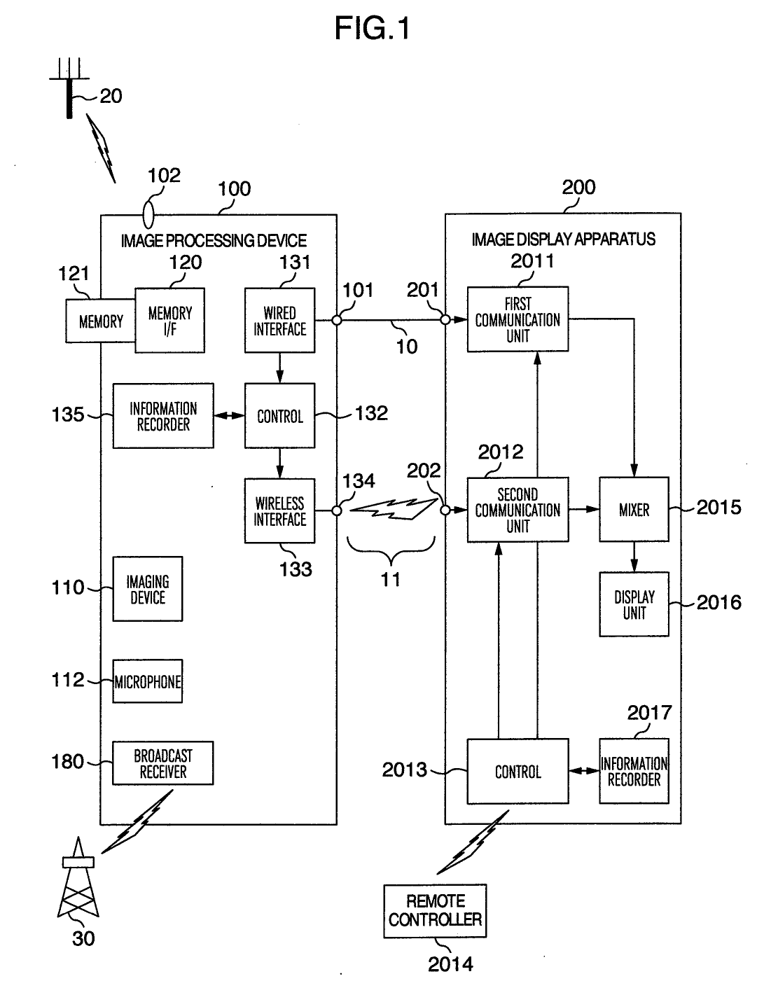

FIG. 1 shows a first embodiment of the present invention. In FIG. 1, for example, image processing devices are illustrated as two image processing devices. One of the two image processing devices is, for example, a portable image processing device 100 which can receive a digital broadcast signal from an antenna 20 of a base station for cellular phone or from a broadcast transmission tower 30. Whereas, the other image processing device is an image display apparatus 200 such as a tuner which can receive a digital broadcast signal from the broadcast transmission tower 30. The image processing device 100 and the image display apparatus 200 are interconnected, for example, by a wired bidirectional interface 10 and also by another wireless bidirectional interface 11. As a result, bidirectional communication of a video signal and other information can be established between the image processing device and the image display apparatus.

In the present embodiment, more specifically, the portable image processing device 100 is a digital camera, a video camera, a cellular phone, a game machine, or a personal media player. The necessary constituent elements of the image processing device vary from specific image processing device to specific image processing device. In the embodiment shown in FIG. 1, however, constituent elements necessary for input/output of the image processing device from/to an external device are illustrated.

In FIG. 1, the antenna 20 of the base station for cellular phone and an antenna 102 of the image processing device 100 act to transmit and receive a signal. When the image processing device 100 is used as a cellular phone, the image processing device performs signal operations as a normal cellular phone. The image processing device 100 also can receive a content of a cinema program or the like sent from the cellular phone base station antenna 20. In this case, the received content can be viewed by a display apparatus and an audio output device built in the image processing device 100, or also can viewed by an external image display apparatus 200 via a terminal 201 on its large display screen. Further, the content can also be recorded in a storage medium built in the image processing device 100 or in a storage medium (such as a memory 121) connected to the image processing device 100 during view of the content or to later view the content. The memory 121 can also be used as a medium for recording a cinema or the like.

A program broadcasted from the broadcast transmission tower 30 is received by a broadcast receiver 180 of the image processing device 100. The received program can be viewed by the image processing device 100, or can be recorded in a storage medium (not shown) built in the image processing device 100 or in a storage medium (such as the memory 121) connected thereto. The received program can also be viewed on the image display apparatus 200 after the program is received from the image processing device 100 via a terminal 101, a connection cable 10 and a terminal 201.

When an imaging device and a microphone 112 are mounted to the image processing device 100, a still or motion picture can be photographed by the mounted devices together with its audio signal, and can be stored in a storage medium (not shown) or in the memory 121 built therein as necessary. The video and audio signals stored in the built-in storage medium or the memory 121 can be sent to the image display apparatus 200 via the terminal 101, the connection cable 10 and the terminal 201, and can be viewed on the image display apparatus 200.

The embodiment shown in FIG. 1 shows when the terminal 101 of the image processing device 100 is connected to the terminal 201 of the image display apparatus 200 by the connection cable 10 and when a terminal 134 of the image processing device 100 is connected to a terminal 202 of the image display apparatus 200 via a space 11 respectively.

Explanation will next be made as to the operation of the present embodiment by referring to FIG. 1. Explanation will be made when the image processing device 100 and the image display apparatus 200 are interconnected not by a wireless interface but by a wired interface alone of the connection cable 10. In this case, normal wired interface connection is made. More specifically, this wired interface connection may be achieved, for example, using the HDMI interface.

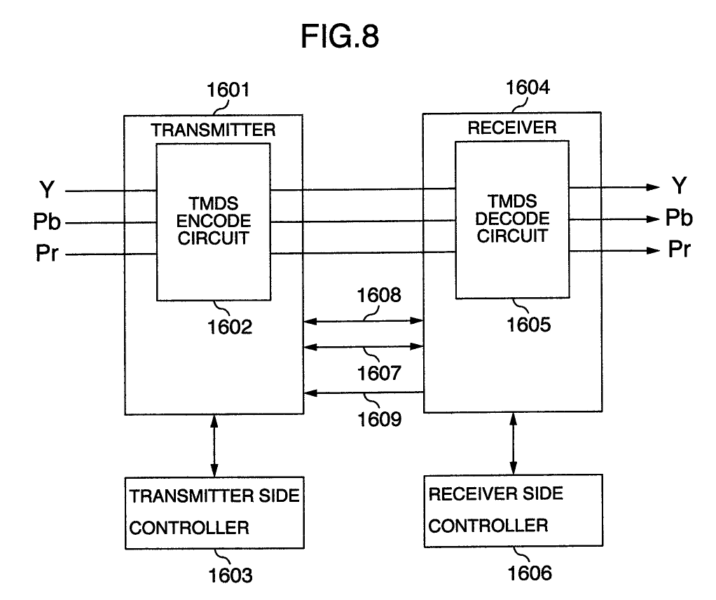

Complementary explanation will be made as to the HDMI interface. FIG. 8 shows an example of an arrangement of the HDMI interface having mainly a transmission side and a reception side. The transmission side includes a transmitter 1601 and a transmission side controller 1603 for controlling the transmitter 1601. The transmitter 1601 is arranged to encode a video signal (Y, Pb, Pr or R, G, B) and an audio signal and to transmit the encoded signals to a receiver 1604. The transmitter 1601 further includes a TMDS encode circuit 1602, and converts the video signal (Y, Pb, Pr or R, G, B) and the audio signal to serial video data and serial audio data respectively. On the other hand, the reception side has the receiver 1604 and a transmission side controller 1606 for controlling the receiver 1604. The receiver 1604 decodes the video and audio data transmitted from the transmitter 1601 to a TMDS signal according to TMDS (Transition Minimized Differential Signaling) by a TMDS decoder 1605, and regenerates video and audio data for a baseband signal. A CEC line 1607 forms a device control line for transmitting a device control signal, and display specification information called DDC is transmitted through a DDC line 1608. The receiver side sends an HPD (Hot Plug Detect) signal 1609 indicative of a connection between a transmission side device and a reception side device to the transmission side.

In the HDMI specifications, for transmission of data or a signal, mutual recognition between devices is carried out according to the following procedure. First, physical addresses of the devices are acquired using the DDC line 1608. The physical address is an identification number for distinction between the devices. Logical addresses are then acquired for bidirectional communication between the devices using the CEC bus as a bidirectional connection. The logical address is identification information which defines the category of each of devices including a display apparatus and a recorder.

Returning again to FIG. 1, explanation will be made in connection with a case when the connection between the image processing device 100 and the image display apparatus 200 is carried out not through the connection cable 10 but through the wireless interface. In this case, their physical addresses and logical address are wirelessly acquired according to a procedure similar to the normal wired interface connection, and thereafter the connection is carried out using these addresses. The wireless connection may be carried out, for example, using a procedure similar to the HDMI interface in a predetermined frequency band.

Explanation will next be made in connection with a case when the wired and wireless interfaces are both connected and used. This connection is effective when the image processing device 100 and the image display apparatus 200 are interconnected with a short distance therebetween and user is stably watching or listening to a program without being influenced by external noise, and also when it is desired to move the image processing device 100 or the image display apparatus 200 while the connection between the image processing device 100 and the image display apparatus 200 is maintained.

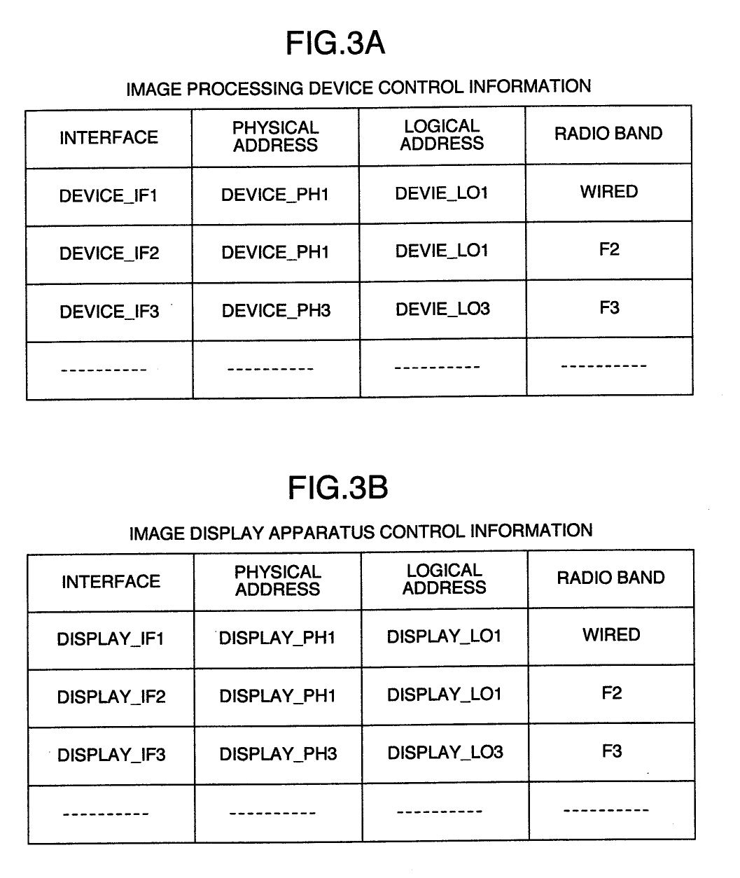

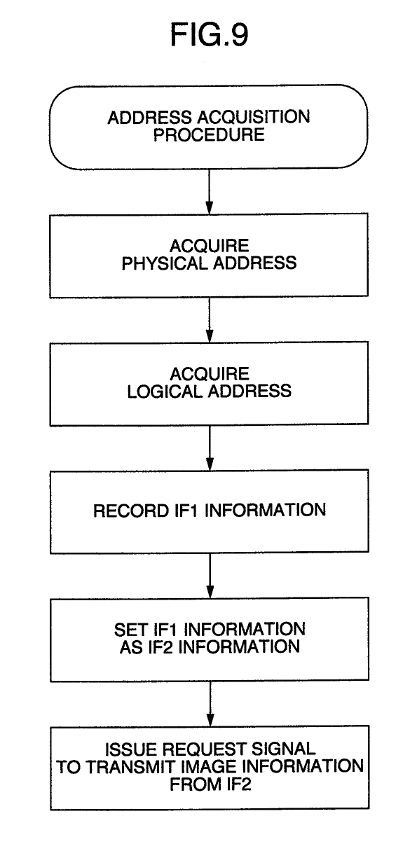

FIG. 9 is a diagram for explaining a connection procedure in the above case. After the power of the image processing device 100 and the power of the image display apparatus 200 become valid respectively, control circuit 132 and 2013 acquire both physical addresses according to respective predetermined procedures, and record the acquired physical addresses of the respective devices and apparatus in respective information recording circuit 135 and 2017 of the image processing device 100 and the image display apparatus 200. And the control circuits acquire both logical addresses according to predetermined procedures, and records the acquired logical addresses of the respective device and apparatus in the respective information recording circuits 135 and 2017 of the image processing device 100 and the image display apparatus 200. The states of the information recording circuits 135 and 2017 are shown in FIGS. 3A and 3B. In other words, the contents recorded in the information recording circuit 135 of the image processing device 100 are shown in FIG. 3A, and the contents recorded in the information recording circuit 2017 of the image display apparatus 200 are shown in FIG. 3B. At the current time point, information are recorded as far as the second row both in FIGS. 3A and 3B. On the basis of the information of the information recording circuits 135 and 2017, information transmission based on the wired interface is carried out.

With such an arrangement, the wired HDMI interface and the wireless interface can be commonly used, the control circuits 132 and 2013 and the information recording circuits 135 and 2017 can be commonly used, and the connection procedures of the interfaces can be commonly used. When a plurality of wireless interfaces are used at near positions, the interfaces interfere mutually. For this reason, it is necessary to manage a use frequency band. Setting of the frequency band may manually carried out by the user, or a plurality of bands may be prepared and setting of the bands may be carried out automatically according to the detected use states of the bands. The frequency band set in this manner is unnecessary for the wired interphase, but is necessary for the wireless interface, and is managed by the information recording circuits 135 and 2017.

Consider a case when the user wants to move the image processing device 100 and the image display apparatus 200 with the connection between the 100 and the image display apparatus 200 kept. The user instructs the image display apparatus 200 using a remote controller 2014 or a control key or the like on the image display apparatus 200 to be connected to the wireless interface. This causes the control circuit 2013 of the image display apparatus 200 to receive the connection instruction information, and the image display apparatus 200 instructs the image processing device 100 to copy information in the information recording circuit 135 so far used for the current image processing device 100 as new wireless interface information to get ready for the operation of the wireless interface. The instruction from the image display apparatus 200 to the image processing device 100 is transmitted to the control circuit 132 via a wired interface circuit 2011, the terminal 201, the connection cable 10, the terminal 101, and a wired interface circuit 131. The control circuit 132 interprets this instruction, copies information about the wired interface present on the second row of the information recording circuit 135, and records the copied information as it is as information about the wireless interface.

This eliminates the need for acquiring physical and logical addresses usually when the wireless interface connection is required. Thus the wireless interface connection can be achieved in a short time. After the wireless interface connection is established, the control circuit 2013 controls a mixer circuit 2015, sends a signal from the wireless interface to a display unit 2016, and displays on the display screen the fact that changeover was made to the wireless interface. This changeover display is not necessarily to be given on the display unit but may be given by a light emitting element such as LED on the image display apparatus. After the user recognizes the fact that changeover is made to the wireless interface and then removes the connection cable 10 from the respective device and apparatus, the user can move these device and apparatus to a desired place while watching and listening to the program. Even when the broadcast receiver 180 as an example is selected as a signal source so far used in the image processing device 100, the user advantageously can eliminate the need for newly again setting the program so far used in the broadcast receiver 180, can watch or listen to the program as it is, increasing a user's convenience.

Information about the wireless interface in the information recording circuits 135 and 2017 is stored and remains in such a nonvolatile memory that the information is stored as it is, even when the power of the image processing device 100 and the power of the image display apparatus 200 are turned OFF. Thus, when the power of the image processing device 100 and the power of the image display apparatus 200 are again turned ON, the same connection information can be used as it is. This can eliminate the need for again setting these device and apparatus whenever used, and can provide such an arrangement as to have an excellent handleability.

As will be clear from the contents so far explained above, the wired and wireless interfaces for interconnection between the plurality of devices are controlled using the wired interface, with the result that there is no risk that erroneous control information is given to a device not associated therewith and causes erroneous operation thereof. Since the wired interface is used, the system advantageously can be resistant to noise or the like and have a high reliability.

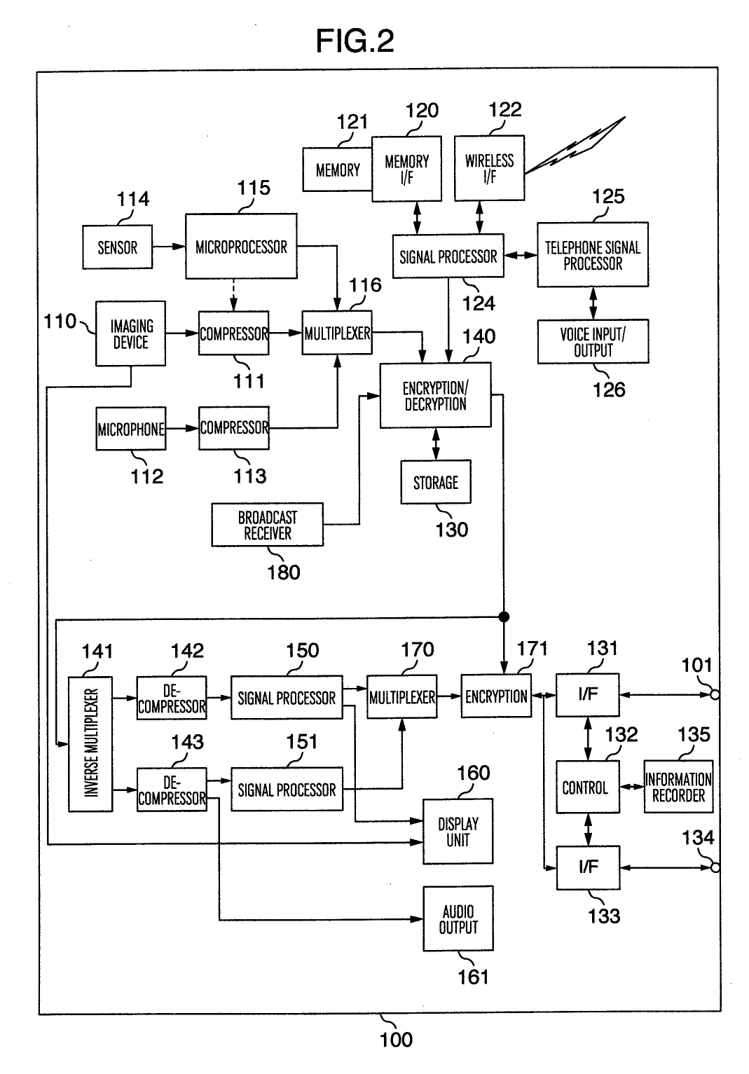

FIG. 2 is a first embodiment of the present invention, showing a specific arrangement of the image processing device 100 in FIG. 1.

An imaging device 110 captures an image such as a motion picture or a still picture from its optical system and converts the image to an electric signal. A compressor circuit 111 efficiently performs bit compression on the captured image. More specifically, when the captured image is a motion picture, the compressor circuit 111 performs bit compression on the image using a compression scheme such as MPEG2, MPEG4, or AVC/H.264 to obtain a motion picture signal. When the captured image is a still picture, the compressor circuit 111 performs bit compression on the image using a compression scheme such as JPEG to obtain a still picture signal.

The microphone 112 converts a voice or sound to an electric signal. A compressor circuit 113 efficiently performs bit compression on the captured sound signal using a compression scheme such as MPEG audio.

A multiplexer circuit 116 receives bit-compressed video and audio signals from the compressor circuits 111 and 113 and further receives various types of information from a microprocessor 115. The multiplexer circuit 116 performs multiplexing operation using these information according to a predetermined format. When a still picture is photographed, a sound signal is usually not captured. However, the sound signal may also be multiplexed according to the still picture photographing.

Various types of information from the microprocessor 115 include positional information (horizontal, right vertical, left vertical), date and exposure information when photographed, used in a sensor 114.

In FIG. 2, a signal multiplexed by the multiplexer circuit 116 is sent via an encryption/decryption circuit 140 to a storage 130, and stored in the storage 130. The storage may be, for example, a hard disk, an optical disk or a semiconductor memory. Selection of such hard disk, optical disk and semiconductor memory is determined by considering desired storage capacity and size, ease in storage medium removal and the price. The multiplexed signal may also be sent via a signal processing circuit 124 and a memory interface 120 to the memory 121, and then stored in the memory 121.

With respect to information on an image personally photographed, since the user itself as a photographer has the copyright on the image, the image information is usually not required to be encrypted for its storage. However, a medium having information stored in the storage 130 recorded therein may be lost. To avoid this, an output signal of the multiplexer circuit 116 is encrypted by the encryption/decryption circuit 140 and then stored in the storage 130 or in the memory 121, thus assuring a security.

There is a case when a removable memory can be mounted in the image processing device 100 or when the image processing device 100 can have a cellular phone function or a wireless LAN function. The memory interface 120 is an interface with the removable memory 121, a video/audio content of a still or motion picture is recorded in the memory 121 in the other device, and the memory 121 is connected to the memory interface 120 so that the a content can be sent via a signal processing circuit 124 and the encryption/decryption circuit 140 to the storage 130 and be recorded in the storage 130.

At this time, the content recorded in the memory 121 is protected by copyright, the signal processing circuit 124 detects whether or not the duplication of the content is restricted, the content is encrypted by the encryption/decryption circuit 140 according to the detected conditions, and then sent to the storage 130.

Similarly, even when a video/audio content of an image of a still or motion picture is received in or input to a wireless interface 122, the content is sent via the signal processing circuit 124 and the encryption/decryption circuit 140 to the storage 130 and then recorded in the storage 130. Even in this case, the content is encrypted by the encryption/decryption circuit 140 as necessary according to the copyright protection and duplication limitation conditions for the content.

When the user wants to watch or listen to one of the contents stored in the storage 130 by reproducing the content, the user selects desired one of the stored contents using an input key (not shown) or a remote controller. This causes the selected content to be read out from the storage 130, be decrypted by the encryption/decryption circuit 140, and be separated by an inverse multiplexer circuit 141 into video and audio signals.

When a broadcast signal is received at the broadcast receiver 180, the broadcast signal encrypted for broadcast is decrypted by the encryption/decryption circuit 140, encrypted for storing as necessary by the same encryption/decryption circuit 140, and then recorded in the storage 130 and in the memory 121. When the user wants to directly watch or listen to the received broadcast program, the broadcast signal is separated by the inverse multiplexer circuit 141 into video and audio signals.

The separated and compressed video signal is decompressed by a decompressor circuit 142 and applied to a signal processing circuit 150. The signal processing circuit 150 performs scan line conversion according to the number of scan lines in a display unit 160 and then sends its output to the display unit 160. The separated and compressed audio signal is decompressed by a decompressor circuit 143 and applied to an audio output unit 161. In this way, since the image processing device 100 has the display unit 160 and the audio output unit 161, the user can directly watch or listen to the program while eliminating the need for connecting the image processing device 100 to an external image display apparatus. When there is a difference in the video display and the audio output caused by a difference in decompression time between the video and audio signals and by the presence or absence of the scan line number converting operation, the audio signal is delayed, for example, during the decompressing operation, called “rip sync”, since the audio signal preceding the video signal, in particular, gives an uncomfortable feeling to the listening user. With such rip sync, user's uncomfortable feeling caused by the time difference between the video and audio signals can be removed.

When the user wants to watch or listen to the video and audio signals on the external image display apparatus 200, the image processing device 100 confirms the number of scan lines conforming to the image display apparatus 200. When the confirmed scan line number coincides with the number of scan lines in the displaying video signal, the image processing device 100 outputs the video signal as it is. Whereas, when no coincidence therebetween is found, the scan line number is converted in the signal processing circuit 150 to the required scan line number. Thereafter, the converted scan line number is multiplexed with respect to time axis together with the audio signal processed by a signal processing circuit 151 in a multiplexer circuit 170. The signal processing circuit 151 performs time axis compression the audio signal during a time corresponding to the blanking period of the audio signal, and also adjusts with respect to time as necessary for the rip sync. The video and audio signals multiplexed by the multiplexer circuit 170 are input to an encryption circuit 171. The encryption circuit 171 performs encrypting operation on the video and audio signals for signal transfer between the image processing device 100 and the image display apparatus 200, sends the encrypted signals via the wired interface circuit 131 to the terminal 101, and outputs the signals from the terminal 101 to the image display apparatus 200. When the interconnection between the image processing device 100 and the image display apparatus 200 is carried out via the wired interface of, e.g., the HDMI system, the encryption circuit 171 employs an HDCP encryption having a key length of 56 bits or less. When the interconnection between the image processing device 100 and the image display apparatus 200 is carried out via the wireless interface, the encryption circuit 171 employs and an AES (Advanced Encryption Standard) encryption having a key length of 128 bits. Changeover between the encryption systems is carried out by firmware.

When it is desired to store the signal output from the terminal 101 in its reception destination, the output signal is not decompressed. In this case, the compressed signal is sent from the encryption/decryption circuit 140 to the encryption circuit 171 to be encrypted therein for transmission, sent to the terminal 101 via the wired interface circuit 131, and then output from the terminal 101.

In the above explanation, the video and audio signals captured from the imaging device 110 and the microphone 112 and the content received from the memory 121 and from the wireless interface 122 have been arranged to be once recorded in the storage 130, and then to be reproduced. However, when it is unnecessary to store the content or when it is desired to directly watch or listening to the content, it is only required not to encrypt or decrypt the content signal to store it in the encryption/decryption circuit 140 but to process the signal in the inverse multiplexer circuit 141. With such an arrangement, the user can watch or listen to the video and audio signals with use of the display unit 160 and the audio output unit 161 built in the image processing device 100, or can watch or listen to the video and audio signals with use of a receiver externally connected via the wired interface circuit 131.

Explanation will then be made in connection with a case where the image processing device 100 is used as a cellular phone. A voice such as a conversation is input to a voice input/output unit 125, subjected by a telephone signal processing circuit 125 to predetermined signal processing and modulation, and then transmitted from the base station antenna 20 to the cellular phone base station. As in the reception of a signal from a telephone line, a voice transmitted from the base station is received at the base station antenna 20, subjected by the telephone signal processing circuit 125 to predetermined voice signal processing and demodulation, supplied to the telephone signal processing circuit 125, and then output as a voice therefrom. The image processing device 100 also can receive such a content as a motion picture transmitted from the base station of the cellular phone. In this case, the received content is received at the base station antenna 20, and supplied to the signal processing circuit 124 via the telephone signal processing circuit 125. Thereafter, the content is subjected by the encryption/decryption circuit 140 and so on to such processing as mentioned above, so that the user can watch or listen to the content with use of the display unit and the audio output unit built in the image processing device 100. The user also can watch or listen to the thus-processed content on a large screen of the external image display apparatus 200 via the terminal 101, the connection cable 10 and the terminal 201. Further, the content may also be recorded in a storage medium built in the image processing device 100 or in a storage medium (such as memory 121) connected to the image processing device 100 during view of the content or for later view of the content. The memory 121 can also be used as a recording medium for recording a cinema or the like.

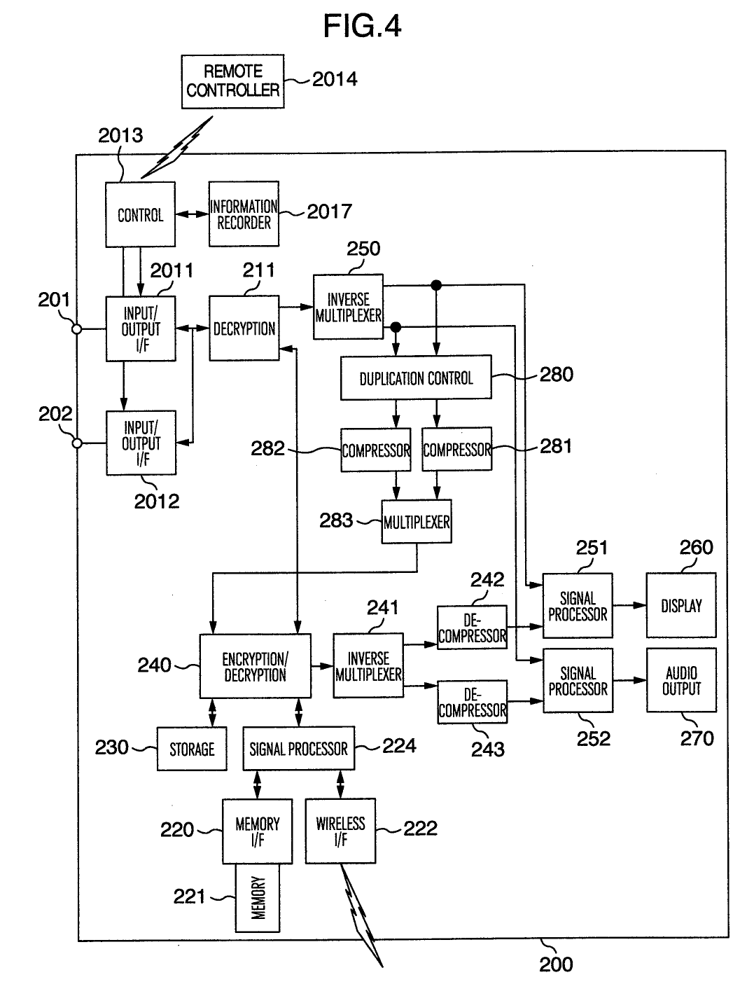

FIG. 4 shows a specific arrangement of the image display apparatus 200 shown in FIG. 1. Constituent elements having the same functions as those in FIG. 1 are denoted by the same reference numerals, and detailed explanation thereof is omitted.

Explanation will first be made in connection with a case where a signal input from the terminal 201 is a baseband signal for a motion picture not compressed. The signal input from the terminal 201 is input to a decryption circuit 211 via a wired input/output interface circuit 210. The decryption circuit 211 is associated with the encryption of the encryption circuit 171 shown in FIG. 2, and acts to decrypt the signal encrypted by the encryption circuit 171. The decrypted signal is input to an inverse multiplexer circuit 250, which in turn inputs video and audio signals as its outputs to signal processing circuits 251 and 252 respectively. The signal processing circuit 251 performs converting operation of scan line number and resolution according to the number of pixels displayable on a display unit 260. The signal processing circuit 252 performs time axis expansion on the audio signal time-axis compressed and multiplexed to the blanking of the audio signal, and as necessary, performs rip sync, voice quality adjustment and so on the decompressed signal. Output signals from the signal processing circuits 251 and 252 are output to the display unit 260 and an audio output unit 270 respectively for user's view.

Explanation will next be made in connection with a case where a compressed motion picture signal is received from the terminal 201. The purpose of receiving the compressed signal is to store the motion picture signal in a storage 230 built in the image display apparatus 200.

The signal received from the terminal 201 is applied to the decryption circuit 211 via the wired input/output interface circuit 2011. The decryption circuit 211, which is associated with the encryption of the encryption circuit 171 shown in FIG. 2, acts to decrypt the signal encrypted by the encryption circuit 171. The decrypted signal is sent to an encryption/decryption circuit 240. The encryption/decryption circuit 240 in turn reads out copy control information about the storage-target content and encrypts the signal according to the copy control information for its storage. The encrypted signal is input to the storage 230 and stored therein in its compressed state. When the interconnection between the image processing device 100 and the image display apparatus 200 is carried out via a wired interface of the HDMI system or the like as in the aforementioned encryption circuit 171, the system employs an HDCP encryption having a key length of 56 bits or less. When the interconnection between the image processing device 100 and the image display apparatus 200 is carried out via a wireless interface, the system employs an AES encryption having a key length of 128 bits. Changeover between the encryption schemes is carried out by firmware.

When the user wants to watch or listen to the compressed signal received from the terminal 201 during storing operation of the signal, the compressed signal decrypted by the decryption circuit 211 is first sent from the encryption/decryption circuit 240 to an inverse multiplexer circuit 241. Subsequently, the inverse multiplexer circuit 241 in turn separates the input signal into compressed video and audio signals. The separated video and audio signals are decompressed by decompressor circuit 242 and 243 to original baseband signals, and then applied to the signal processing circuits 251 and 252, respectively. As in the above case, the baseband signals are input to the display unit 260 and the audio output unit 270 for user's view.

When the user wants to reproduce and view a content stored in the storage 230, the user selects one of titles of the contents stored in the storage 230 and displayed on the display unit 260 to input the selected content signal from the storage 230 to the encryption/decryption circuit 240. The selected content signal is decrypted by the encryption/decryption circuit 240, input to the inverse multiplexer circuit 241, and processed in a manner similar to the above, whereby the user can view the selected content.

Similarly, the content stored in a memory 221 can also be reproduced. As in the reproduction of the content stored in the storage 230, the user selects desired one of the contents stored in the memory 221. This causes the selected content to be input to the encryption/decryption circuit 240 via a memory interface 220 and a signal processing circuit 224. The signal processing circuit 224 in turn performs operation necessary for reading out the content from the memory 221, and inputs the compressed and multiplexed video and audio signals to the encryption/decryption circuit 240. The subsequent signal processing is carried out in a manner similar to when a content is read out from the storage 230.

As in the case of storing a content in the storage 230, a content can be stored in the memory 221. Although detail explanation of the then processing operation is omitted, the content encrypted by the encryption/decryption circuit 240 is sent to the memory 221 via the signal processing circuit 224 and the memory interface 220, and then stored in the memory 221.

Even when the user wants to view or store a content wirelessly transmitted, similar operation is carried out. A compressed content wirelessly transmitted is input to the encryption/decryption circuit 240 via the wireless interface 222 and the signal processing circuit 224. The encryption/decryption circuit 240 decrypts the encryption necessary for wireless transmission. The subsequent processing operation is similar to the processing operation when a content from the storage 230 is reproduced.

Even when a noncompressed baseband signal is received from the terminal 201 or 202, its content can be efficiently stored in the storage 230 or the memory 221. The then operation will be explained below.

The content received from the terminal 201 is separated into video and audio signals through the wired input/output interface circuit 2011, the decryption circuit 211 and the inverse multiplexer circuit 250. The separated video and audio signals are input to compressor circuit 281 and 282 via a duplication control circuit 280. The duplication control circuit 280 reads out duplication control information multiplexed in the input content and determines whether or not the duplication is allowed. The duplication control information can also be multiplexed to the video or audio information using a technique for allocating bits to specified parts or using a digital watermarking technique.

The compressor circuit 281 compresses the video signal based on such a compression scheme as MPEG2, MPEG4, or AVC/H.264. The compressor circuit 282 compresses the audio signal based on such a compression scheme as MPEG audio. The compressed video and audio signals are input to a multiplexer circuit 283, multiplexed therein, and then input to the encryption/decryption circuit. In the subsequent operation, the signal can be similarly stored in the storage 230 or the memory 221. As a result, long-time recording of the content can be efficiently attained according to the copyright information.

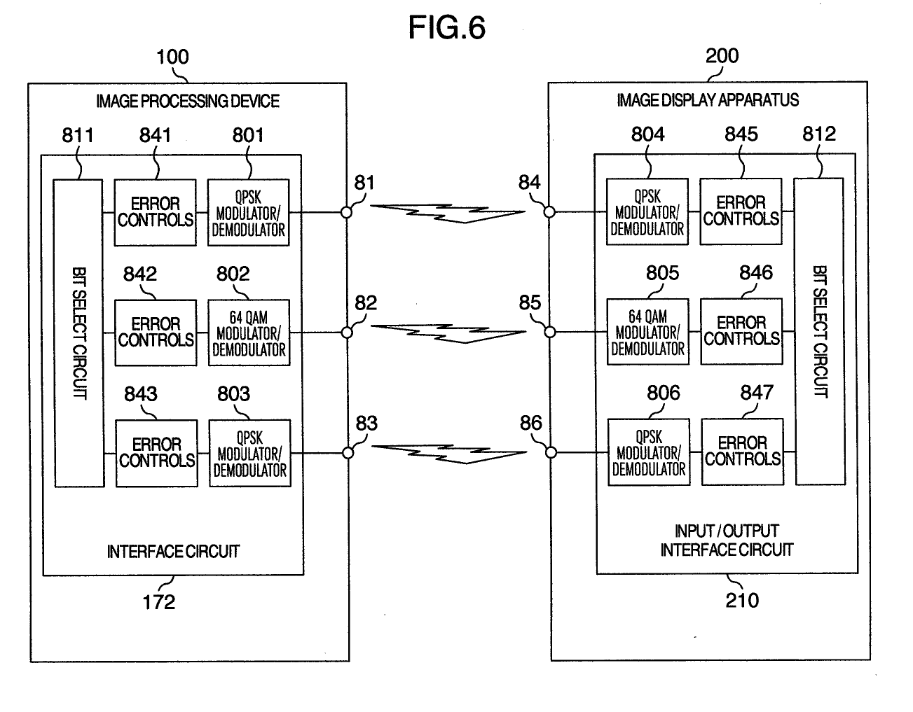

FIG. 6 is a diagram for complementarily explaining the wireless interface 11 between the image processing device 100 and the image display apparatus 200. In FIG. 6, the image processing device 100 and the image display apparatus 200 are the same as those already explain in FIGS. 1, 2 and 4. In FIG. 6, for simplicity of explanation, only a wireless interface circuit 133 is illustrated as one of the constituent elements of the image processing device 100, and the other constituent elements are omitted. With respect to the image display apparatus 200, only a wireless input/output interface circuit 2012 is illustrated and the other constituent elements thereof are omitted. In this case, the wireless interface circuit 133 and the wireless input/output interface circuit 2012 are both bidirectional interfaces. In FIG. 6, channels between antennas 81 and 84 and between antennas 82 and 85 are used for bidirectional transmission of video and audio signals and a control signal indicative of content copyright protection and/or duplication limitation conditions respectively. A channel between antennas 83 and 86 is for transmission of an interdevice control signal. Bit select circuits 811 and 812 receive the video and audio signals, the control signal indicative of content copyright protection and/or duplication limitation conditions, and the interdevice control signal. In the aforementioned modulation/demodulation system, a QPSK (Quadrature Phase Shift Keying) modulation/demodulation system has a resistance to transmission error higher than a 64 QAM (Quadrature Phase Shift Keying) modulation/demodulation system. Meanwhile, the 64 QAM modulation/demodulation system has a transmission efficiency higher than the QPSK modulation/demodulation system. Explanation will now be made in connection with a case where the video and audio signals and the control signal indicative of the copyright protection of a content associated with the video and audio signals and duplication limitation conditions thereof are transmitted from the image processing device 100 to the image display apparatus 200. It is assumed in this case that a direction of information transmitted from the image processing device 100 to the image display apparatus 200 is denoted by “up”, while a direction of information transmitted from the image display apparatus 200 to the image processing device 100 is denoted by “down”.

In order for the image processing device 100 to transmit information, a carrier detection circuit (not shown) first examines whether or not a used channel is already occupied by another device. This carrier detection is carried out by detecting the presence or absence of a carrier in a predetermined frequency band during a predetermined time. When the carrier detection circuit detects the fact that the channel is used by the other device, the carrier detection circuit waits for a while and again examines the presence or absence of the idle state of the channel. Thereafter, when detecting the fact that the channel is not used by the other device, the carrier detection circuit informs the microprocessor 115 of the image processing device 100 of the fact of the idle channel.

The microprocessor 115 causes a channel use request signal to be output from a QPSK modulation/demodulation circuit 803 to secure a channel use authority. The microprocessor 115 then outputs a transmission request signal to the bit select circuit 811. An error control circuit 843 adds an error control bit for error detection and correction to the transmission request signal and sends the bit-added signal to the QPSK modulation/demodulation circuit 803. The QPSK modulation/demodulation circuit 803 performs QPSK modulating operation on the received signal and transmits a wireless signal from the antenna 83 to the image display apparatus 200. In the side of the image display apparatus 200, on the other hand, a QPSK modulation/demodulation circuit 806 QPSK demodulates the wireless signal received at the antenna 86, an error control circuit 847 performs error detection and correction control on the demodulated signal to obtain an interdevice control signal and outputs the interdevice control signal to the bit select circuit 812.

The microprocessor in the image display apparatus 200 interprets the received interdevice control signal receives device category information (for distinguishing between categories to know whether the device is a display device or a recorder device) about the image processing device 100 and a device identification number for the image processing device 100 together with the transmission request signal from the image processing device 100. Since a message indicative of whether or not the image display apparatus 200 should be connected to the image processing device 100 appears on the display screen of the image display apparatus 200, the user issues an instruction to allow the connection with the image processing device 100 with use of an input device such as a remote controller for the image display apparatus 200 on the basis of the appeared message. Thereafter, the image processing device 100 and the image display apparatus 200 exchange device category information about these device and apparatus, identification number for distinction between the device and apparatus, and so on; and executes information exchange to confirm to the content copyright protection/duplication limitation conditions. When there is found no problem between the image processing device 100 and the image display apparatus 200, the interconnection therebetween is allowed. When the interconnection is meaningless as when the device and apparatus are both input- or output-exclusive device and apparatus, or when the interconnection leads to a breach of the content copyright protection or duplication limitation conditions, the interconnecting operation is stopped and a message indicative of the fact is displayed on the device and apparatus. Explanation will be made in connection with a case where there is no problem in the content copyright protection or duplication limitation conditions.

Of the video and audio signals and the control signal indicative of the copyright protection or duplication limitation conditions of the content associated therewith, received in an interface circuit 172; the video signal is selected, and two bits of the video signal are selected from the MSB (Most Significant Bit) of the video signal. The error control circuit 841 adds an error detecting/correcting control bit to the two bits, and sends it to a QPSK modulation/demodulation circuit 801. The QPSK modulation/demodulation circuit 801 performs QPSK modulating operation on the received signal and transmits a wireless signal from the antenna 81. An error control circuit 842 adds an error detecting/correcting control bit to the remaining bits from the third to eighth bits, and sends it to a 64 QAM modulation/demodulation circuit 802. The 64 QAM modulation/demodulation circuit 802 performs 64 QAM modulating operation on the received signal, and transmits it as a wireless signal from the antenna 82.

In the side of the image display apparatus 200, a QPSK modulation/demodulation circuit 804 performs QPSK demodulating operation on the signal received at the antenna 84. An error control circuit 845 performs error control on the QPSK-demodulated signal. Upper two bits of the video signal are output to the bit select circuit 812. A 64 QAM modulation/demodulation circuit 805 performs 64 QAM demodulating operation on the remaining signal received at the antenna 85. An error control circuit 846 perform error control on the 64 AQM-demodulated signal, and then outputs it to a bit select circuit 812.

The interdevice control signal will now be explained. When the interdevice control signal is transmitted in a down direction, that is, from the image display apparatus 200 to the image processing device 100; the interdevice control signal is sent from the bit select circuit 812 via the error control circuit 847 to the QPSK modulation/demodulation circuit 806, modulated in the QPSK modulation/demodulation circuit 806, and then output from the antenna 86. In the image processing device 100, this signal is received from the antenna 83, sent via the QPSK modulation/demodulation circuit 803 to the QPSK modulation/demodulation circuit 803, subjected to QPSK demodulation by the QPSK modulation/demodulation circuit 803, subjected to error detecting/correcting operation by the error control circuit 843, and then sent to the bit select circuit 811. When the interdevice control signal is transmitted in an up direction, that is, from the image processing device 100 to the image display apparatus 200, on the contrary; the signal is sent from the bit select circuit 811 via the error control circuit 843 to the QPSK modulation/demodulation circuit 803, modulated by the QPSK modulation/demodulation circuit 803, and then output from the antenna 83. In the image display apparatus 200, this signal is received from the antenna 86, subjected by the QPSK modulation/demodulation circuit 806 to QPSK demodulation, subjected by the error control circuit 847 to error detecting/correcting operation, and then sent to the bit select circuit 812. With such an arrangement, the system can advantageously provide less erroneous operation even when the interdevice control signal important for system formation is exposed to a noisy environment.

In the arrangement of the present embodiment, the upper two bits of a digital signal have a low transmission rate, but can have an excellent noise-resistance performance transmission. In other words, the fact that the upper bits of a video signal have more influence on the picture quality is utilized. To this end, two bits are sequentially extracted from the MSB of the video signal, transmission channels using the QPSK modulation are allocated to the two bit information to minimize deterioration of the picture quality. In such a system that audio information is more important than video information, it is also possible to allocate transmission channels using the QPSK modulation to important two bits (for example, upper bits) of the audio signal.

In general, when human recognizes an image, with respect to each of frequency components of the image in horizontal and vertical directions, she or he tends to be more unnoticeable to high frequency components than low frequency components. In addition, of objects moving in the displayed image, a fast moving object tends not to be able to be followed by human eye. By utilizing this fact, the horizontal components of a displayed image may be divided into low and high frequency components, QPSK modulation may be used for the low frequency components, and 64 QAM modulation may be used for the high frequency components. With such an arrangement, a noise resistance can be increased to important information in a limited transmission band and a high overall transmission capacity can be secured. Even with respect to the vertical components of a displayed image, the vertical components may be divided into low and high frequency components, QPSK modulation may be used for the low frequency components, and 64 QAM modulation may be used for the high frequency components. With such an arrangement, a noise resistance can be increased to important information in a limited transmission band and a high overall transmission capacity can be secured. In addition, the method of handling the horizontal frequency components of the displayed image and the method of handling the vertical frequency components of the image can also be combined to increase a noise resistance to desired important information.

The above explanation has been made in connection with the case where the error control circuits 841, 842 and 843 add error control information to bits received in the error control circuits 841, 842 and 843 respectively. However, the bits received in the error control circuits 841, 842 and 843 may be treated as a single word and error control information may be added to the word. With such an arrangement, the error control circuit can be easily arranged.

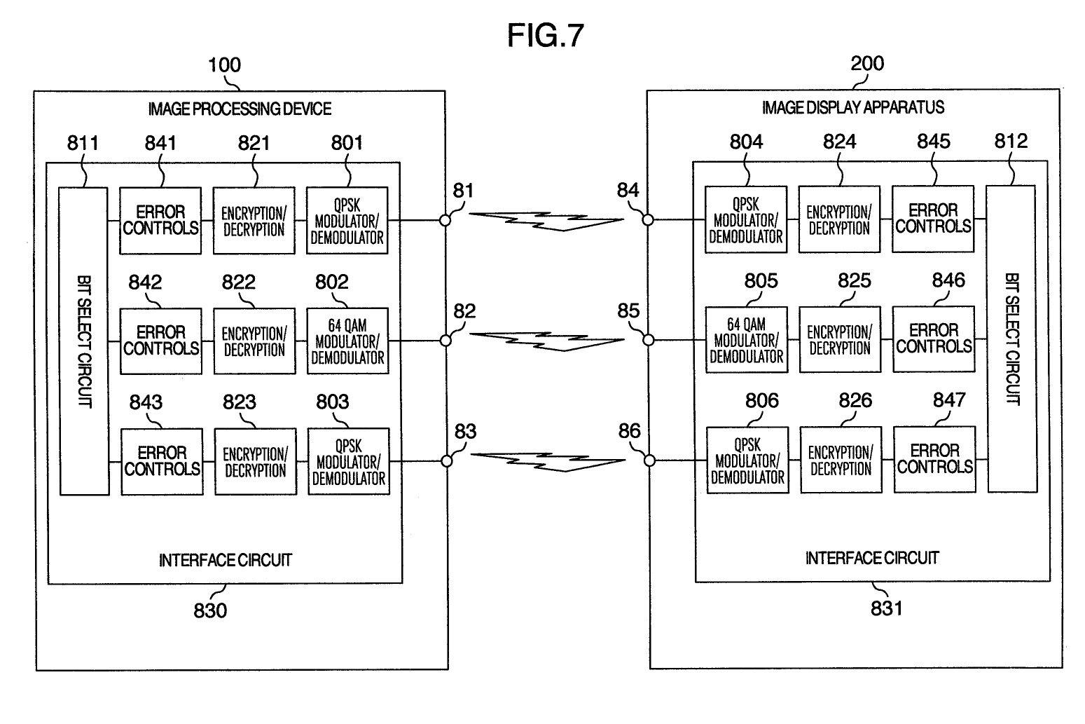

Although encrypting operation is not detailed in the embodiment of FIG. 6, the encryption circuit 171 and the interface circuit 172 can also be combined to provide such operation as shown in FIG. 7. FIG. 7 shows an example of an arrangement of the system of FIG. 6 for encrypting operation. The system of FIG. 7 includes encryption/decryption circuits 821 to 826, interface circuits 830 and 831 including the encrypting operation, and error control circuits 841, 842, 843, 845, 846 and 847.

In the example of FIG. 7, as in the example of FIG. 6, predetermined bits are selected by the bit select circuit 811, subjected by the error control circuits 841 and 842 to error control, encrypted by the encryption/decryption circuits 821 and 822, and then input to the QPSK modulation/demodulation circuit 801 and the 64 QAM modulation/demodulation circuit 802 respectively. Signals demodulated by the QPSK modulation/demodulation circuit 804 and the 64 QAM modulation/demodulation circuit 805 are sent to the encryption/decryption circuits 824 and 825 to be decrypted, and then bit combined by the bit select circuit 812. With such processing as mentioned above, signal processing can be carried out according to importances, and important information can be made less erroneous. As a result, the deterioration of a picture quality can be minimized and transmission can be efficiently carried out.

When the encryption/decryption circuits 821 to 826 are combined with lossless coding, transmission can be carried out more efficiently. In the example of FIG. 7, for example, before signals are encrypted by the encryption/decryption circuits 821 to 823, the number of bits to be transmitted is reduced by arithmetic lossless coding using, e.g., a statistical characteristic, and then the bits are encrypted. In the image display apparatus 200, the signals are decrypted by the encryption/decryption circuits 824 to 826, decrypted by lossless coding associated with the encryption/decryption circuits 821 to 823, subjected by the error control circuits 845 to 847 to error detecting/correcting operation, and then bit combined by the bit select circuit 812. Since the combination with the lossless coding enables reduction of the transmission rate of transmission-target information, the transmission can be achieved more efficiently.

The encryption will be further complementarily explained. When all the encryption circuits perform AES 128 bit encryption, protection can be achieved with a high security. In addition to it, when a content encrypting circuit 821 employs the AES 128 bit encryption and the other encryption circuits employ DES encryption, such a system as to achieve good balance between content security and a processing efficient vital to the system can be easily formed.

Further, the system may be configures so that changeover can be made according to the interdevice control signal between the transmission of the baseband signal and the transmission of the compressed signal. With such an arrangement, when the compressed signal is transmitted according to a request of the content protection or the like, transmission having an excellent error resistance in the transmission channel can be achieved by transmitting the signal based on the QPSK modulation. When the baseband signal is transmitted, employment of the 64 QAM modulation enables transmission with a good transmission efficiency.

The operation between the image processing device 100 and the image display apparatus 200 in FIG. 7 is basically the same as the operation between the image processing device 100 and the image display apparatus 200 in FIG. 6. In order for the image processing device 100 to transmit a signal, the carrier detection circuit (not shown) first examines whether or not the used channel is already occupied by another device. The carrier detection is carried out by detecting the presence or absence of a carrier in a predetermined frequency band during a predetermined period. When the carrier detection circuit detects that the fact that the channel is already used by another device, the circuit waits for a while and again examines the idle state of the channel. Thereafter, when the carrier detection circuit detects no use of the channel by another device, the carrier detection circuit informs the microprocessor 115 of the image processing device 100 of the fact of the idle state of the channel. The microprocessor 115 causes the QPSK modulation/demodulation circuit 803 to output a channel use request signal as the interdevice control signal to secure a channel use authority. Next, the microprocessor 115 causes a transmission request signal to be output to the bit select circuit 811.

The error control circuit 843 adds an error detecting/correcting error control bit to the transmission request signal, the bit-added signal is encrypted by the encryption/decryption circuit 823, and then sent to the QPSK modulation/demodulation circuit 803. The QPSK modulation/demodulation circuit 803 performs QPSK modulation on the input signal and the modulated signal is transmitted as a wireless signal from the antenna 83 to the image display apparatus 200. In the image display apparatus 200, the wireless signal received at the antenna 86 is QPSK demodulated by the QPSK modulation/demodulation circuit 806 and decrypted by an encryption/decryption circuit 826. The error control circuit 847 performs error detection/correction control on the demodulated signal to output an interdevice control signal. And the interdevice control signal is sent to the bit select circuit 812. The microprocessor in the image display apparatus 200 interprets the received interdevice control signal, and receives device category information (for distinguishing between categories, e.g., between the display device and a recording device) about the image processing device 100 and the device identification number of the image processing device 100 together with the transmission request signal from the image processing device 100. Since a message indicative of connection or nonconnection with the image processing device 100 appears on the display screen of the image display apparatus 200, the user issues an instruction to allow the connection on the basis of the displayed message using such an input device as a remote controller of the image display apparatus 200. Thereafter, category information about the image processing device 100 and the image display apparatus 200, identification numbers of the device and apparatus for identification therebetween, and so on are exchanged between the image processing device 100 and the image display apparatus 200. Thereafter, the image processing device 100 and image display apparatus 200 exchange their device category information, the device identification numbers, and so on, and exchanges information to comply with content copyright protection or duplication limitation conditions. In the absence of a problem, the interconnection between the image processing device 100 and the image display apparatus 200 is allowed. When it is meaningless to connect the device and apparatus as when the device and apparatus are both of an input or output exclusive type, or as when the interconnection becomes a breach of the content copyright protection or duplication limitation conditions; the system stops the interconnecting operation and displays the breach message on the respective device and apparatus. When the interconnection becomes no breach of the content copyright protection or duplication limitation conditions without any problem, the interconnection is carried out so that video and audio signals and so on are transmitted from the image processing device 100 to the image display apparatus 200.

As has been explained above, in accordance with the present embodiment, the existing wired interface system (for example, HDMI system) and the wireless system can be commonly used. An image display apparatus to be connected to both of an image processing device having an output of the existing wired interface (for example, HDMI system) as well as an image processing device having an output of the wireless system can advantageously increase a handleability and reduce a cost simultaneously.

### Embodiment 2

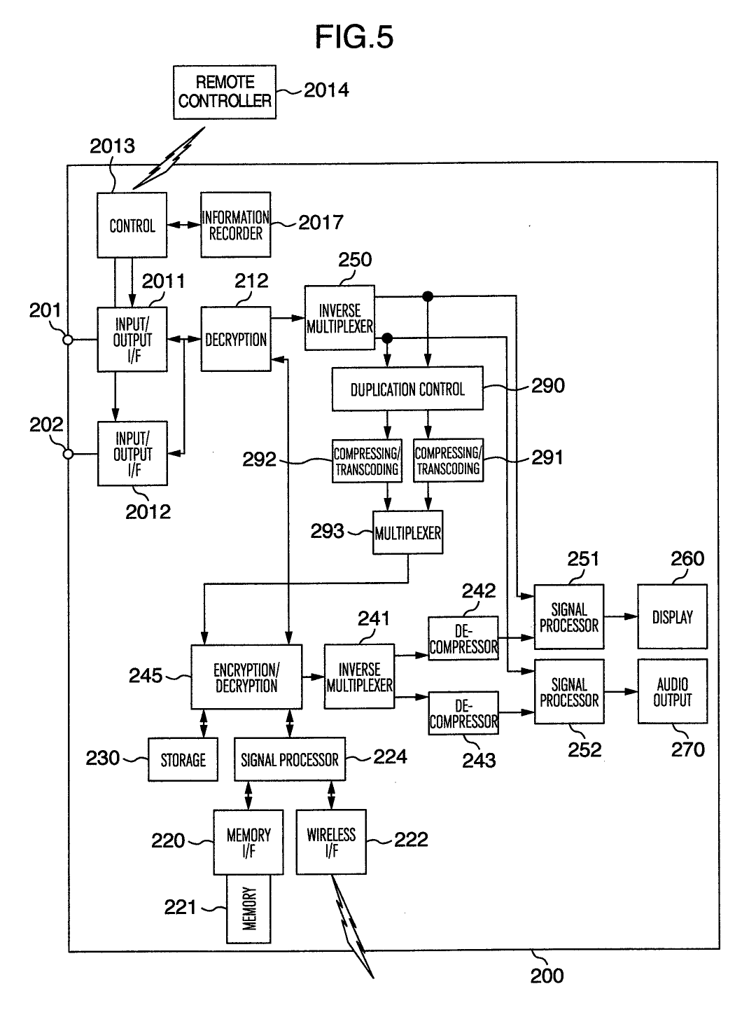

FIG. 5 is a second embodiment of the present invention, showing another arrangement of the image display apparatus 200 shown in FIG. 1. Some of constituent elements in FIG. 5 are the same as those in the embodiment of FIG. 4, the same constituent elements are denoted by the same reference numerals, and detailed explanation thereof is omitted. The image display apparatus 200 shown in FIG. 5 includes a decryption circuit 212, an encryption/decryption circuit 245, a duplication control circuit 290, compressing/transcoding circuits 291 and 292, and a duplication control circuit 293 as a multiplexer circuit.

When a baseband signal is input to the terminal 201 or 202, the embodiment of FIG. 5 is operated in a manner similar to the embodiment of FIG. 4. The compressing/transcoding circuits 292 and 291 are operated as compressor circuits for the baseband signal. When a compressed signal is input to the terminal 201 or 202, the signal is sent via an input/output interface 2011 or 2012 to the decryption circuit 212, decrypted by the decryption circuit 212, and separated by the inverse multiplexer circuit 250 into compressed video signal and audio signals. The video and audio signals are input to the duplication control circuit 290, which in turn determines the permission or non-permission of the duplication on the basis of information indicative of the permission or non-permission of duplication. When the duplication is permitted, the compressed video and audio signals are reduced with respect to bit rate as necessary by the compressing/transcoding circuits 291 and 292, for example, by using a compression system having a good compression efficiency. Output signals from the compressing/transcoding circuits 291 and 292 are multiplexed by the duplication control circuit 293 and sent to the encryption/decryption circuit 245. When the duplication control circuit 290 detects the duplication permission, the encryption/decryption circuit 245 encrypts the input signal for its suitable storage and stores it in the storage 230 and/or the memory 221. When it is desired to reproduce a signal stored in the storage or memory, a reproduction signal from the storage 230 or the memory 221 is decrypted by the encryption/decryption circuit 245, and separated by the inverse multiplexer circuit 241 into video and audio signals. The subsequent operations can be carried out in a manner similar to the above case for user's view. Even when the user wants to view the signal during storing operation thereof in the storage 230 or the memory 221, the signal from the duplication control circuit 293 is sent via the encryption/decryption circuit 245 to the inverse multiplexer circuit 241 and similarly processed. In this case, the transcoded picture quality can be confirmed. When the user wants to directly view the signal without storing the signal, the signal is sent from the decryption circuit 212 via the encryption/decryption circuit 245 to the inverse multiplexer circuit 241, separated in the inverse multiplexer circuit 241 into video and audio signals, and subsequently processed in a manner similar to the above case.

In the embodiment of FIG. 5, even when a compressed signal is input to the image display apparatus 200, the signal can be efficiently stored with a higher compression rate by transcoding the signal. The present embodiment shows an example when the signal processing means are implemented in the form of circuits including the compressor circuits 111 and 113. However, the above processing may be achieved by implementing various types of circuit elements in the form of software. Even in this case, similar effects can be obtained. The present invention is not limited by how to implement the signal processing.

Even in this case, as in the embodiment 1, the existing wired interface system (for example, HDMI system) and the wireless system can be commonly used. Therefore, an image display apparatus to be connected to both of an image processing device having an output from the existing wired interface system (for example, HDMI system) and an image processing device having an output from the wireless system can advantageously increase a handleability and reduce a cost at the same time.

It should be further understood by those skilled in the art that although the foregoing description has been made on embodiments of the invention, the invention is not limited thereto and various changes and modifications may be made without departing from the spirit of the invention and the scope of the appended claims.

1. A display apparatus comprising:
a first communication unit connectable with an external image processing device via a predetermined wired interface for receiving image information from the external image processing device;
a second communication unit connectable with the external image processing device via a predetermined wireless interface for receiving the image information from the external image processing device; and
a display unit for displaying a video based on at least one of pieces of image information received in the first and second communication units,
wherein when an image information acquisition request for receiving the image information based on the wireless interface is issued to the second communication unit, information relating to the image information acquisition request is output from the first communication unit via the wireless interface.

2. The display apparatus according to claim 1, wherein at least any of the image information received in the first and second communication units is compressed image information.

3. The display apparatus according to claim 1 or 2, wherein when the image information acquisition request for receiving the image information in the second communication unit and an image information acquisition request for receiving image information in the other communication unit are issued, a signal for causing release of an image information transmission request for receiving the image information in the second communication unit is output via the wired interface.

4. A display apparatus comprising:
a first communication unit connectable with an external image processing device via a predetermined wired interface for receiving image information from the external image processing device;
a second communication unit connectable with the external image processing device via a predetermined wireless interface for receiving the image information from the external image processing device;
a display unit for displaying an image based on at least one of pieces of image information received in the first and second communication units; and
a storage for storing information for communication control acquired via the wired interface,
wherein the information for communication control stored in the storage is used for connection based on the wireless interface.

5. An image processing device comprising:
a first communication unit connectable with an external display apparatus via a predetermined wired interface for outputting image information to the external display apparatus; and
a second communication unit connectable with the external display apparatus via a predetermined wireless interface for outputting image information to the external image processing device,
wherein the first communication unit receives an image information output request for causing the second communication unit to output the image information based on the wired interface via the wired interface.

6. The image processing device according to claim 5, wherein at least any of pieces of the image information output from the first and second communication units is compressed image information.

7. The image processing device according to claim 5 or 6, wherein a signal for causing release of the image information output request to the second communication unit is input to the first communication unit via the wired interface.

8. An image processing device comprising:
a first communication unit connectable with an external display apparatus for outputting image information to the external display apparatus;
a second communication unit connectable with the external display apparatus via a predetermined wireless interface for outputting image information to the external display apparatus; and
a storage for storing information for communication control acquired via the wired interface,
wherein the information for communication control stored in the storage is used for connection based on the wireless interface.
